(19) United States
(12) Patent Application Publication
(10) Pub. No.: US 2013/0199090 A1
(43) Pub. Date: Aug. 8, 2013

(54) Chlorophyll Seeding and the Estimation and Regulation of Troposphere Carbon Dioxide at the Polar Regions

(71) Applicant: Oscar Alexander Klitin, Saratoga Springs, NY (US)

(72) Inventor: Oscar Alexander Klitin, Saratoga Springs, NY (US)

(21) Appl. No.: 13/744,794

(22) Filed: Jan. 18, 2013

(51) Int. Cl. A01G 1/00

(52) U.S. Cl. CPC A01G 1/00
USPC 47/58.1 R

(57) ABSTRACT

A chemical reaction is presently taking place in the troposphere: carbon dioxide and water vapor interact at low temperature resulting in a very slow reaction rate. The purpose of this publication is to advance the acceleration of such and ultimately regulate the total carbon dioxide in the planet. Usual techniques in improving reaction kinetics are employed. A state formulation with redundant measurements, together with the identification of a reaction state transition matrix is presented. Measurement monitoring and the mathematics keep track of the concentrations of water vapor and carbon dioxide to guide aeration decisions in each state zone.

The chemistry of the troposphere is based on the following unbalanced equation

(6)CO₂+(6) H₂O→(6)O₂+C₆H₁₂O₆ (1)

The balancing is purposely set in (parentheses) since there is an excess of CO₂. Reaction takes place at a very low temperature which makes the reaction rate (5, 6) incredibly long

(some scientists estimate 50 to 100 years to deplete existing CO₂). Additionally noteworthy is the open system environment where the reaction takes place, O₂ diffuses due to volume/altitude, carbohydrate dissolves readily in water and is gone. Should we be so lucky as to accelerate the LHS of this chemical formula to eliminate CO₂ altogether, we would drop the concentration and trigger a new ice age. Thus, monitoring is imperative to prevent this evolution.

Temperature (6) is one of the crucial factors in chemical reaction kinetics. Additional factors are the presence of a catalyst, agitation of the reactants, and size of the particulates. These are all factors to be used in our acceleration.

Temperature (6) is one of the crucial factors in chemical reaction kinetics. Additional factors are the presence of a catalyst, agitation of the reactants, and size of the particulates. These are all factors to be used in our acceleration.

### THE CHEMISTRY OF PHOTOSYNTHESIS

Notice however the similarity of the above (1) with the photosynthesis equation taking place in plants, algae and trees. There are two catalysts involved in the above: sunlight and Chlorophyll. If you compare CO₂ concentrations with the flora areas of the world, you will see that these are doing a very acceptable reduction of CO₂. What do the poles lack, then? Therefore, if we can force a photosynthetic reaction in the polar troposphere, we can consume the CO₂ excesses in these extremes of the planet. Excesses of CO₂ will gravitate to the poles, where we will appropriately operate.

The polar regions have sunlight for 6 months of the year, alternating seasonally. Therefore a seasonal seeding of the poles, with chlorophyll a and b (synthetic version a available since 1960) (8) a-C₅₅H₇₂O₅N₄Mg, b-C₅₅H₇₀O₆N₄Mg, together with the other off setting elements, agitation and aerosol will work to offset the temperature environment (−80 F). Use of a wind tunnel will warm crystallized CO₂. Water vapor in the polar troposphere is well documented using NOAA instrumentation (7). All the ingredients for a synthetic photosynthesis are thus in place.

Care must be taken, however in this process: chlorophyll does not get destroyed . . . it can boil however. You can sense that the above reaction can continue indefinitely. If the CO₂ continues to pour into the polar regions it will balance and overwhelm the excess chlorophyll. Therefore a regulatory balance is what is called for in the reduction of CO₂. Scientists agree that a floor of 250 parts per million of atmospheric CO₂ will not trigger a new Ice Age. Presently worldwide, the CO₂ concentration is growing from present 390 parts per million. You can see that an accurate and deliberate CO₂ monitoring program must be in place with the control of seeding using a feedback mechanism.

Chemical Reaction Rate

The chemical reaction rate obeys the following differential equation:

d[CO₂]/dt: −k [CO₂]^{x} [H₂O]^{y} (2)

In a balanced state, x=y=6. Regardless, we can see, a nonlinear, second order time varying stochastic differential equation, x=1,y=1. This equation can molt: it can go from a 12th order to a second order, or anything in between. The solution of these, in practice, is achieved using numerical methods, except in the simplest cases. Reaction rates, as usual, are affected by temperature, catalysts, particulate size, and agitation of the products. In (2) above [ ] denote concentration, k is a constant.

The balance of these quantities, and the objectives in the open space environment are not the same as in a laboratory. Balance, in our case is achieved via the following equation:

CO₂(new)+CO₂(old)−CO₂(reduction)=CO₂(target) (3)

Thus, if all CO₂ production ceased, we would reach our target and have to stop our reduction procedure.

State Space Formulation for the Troposphere

At the poles, the troposphere extends upwards for about 25 km. The ideal gas equation operates continually in this region. PV=nRT. P represents pressure, V is volume, T is temperature, n and R are constants. Thusly, to take this and other kinetics (convection, radiation, turbulences, etc) into account, a differential breakdown of the polar troposphere should be formulated. I suggest, in view of the timeliness of the seasonal factor, a 6 part division of the

troposphere, approximately 2.1 km each. Thus the troposphere state space will be a 6 variable vector composed of pairs of water vapor and CO₂ concentrations.

We can write the following equation for concentrations of CO₂ and water vapor in state space terminology:

xₖ₊₁=Aₖ xₖ+e (4)

Where e is an error term and A is the transition matrix from k to the k+1 time increment. Both A and e are unknown. X is the troposphere state vector. All we have is a set of concentration measurements taken on a twice weekly basis, say for the various troposphere states, at their corresponding altitudes.

Identification of a State Transition Matrix

Schweppe, Dopazo, Sasson et al (1, 2, 3) have documented the use of measurements to identify power system tie line equivalents. The formulation presented here is similar, though this equation is nonlinear, time varying and stochastic. In other words, we can look inside the A matrix and estimate its terms in numerical relationship to each other. For a 12-tuple state there are 144 elements in the A matrix.

If we stack x vectors into a new matrix Q, we can conform with equation (4) as well using the following new augmentation, Q has more columns than A:

Qₖ₊₁=Aₖ Qₖ+w (5)

We want to minimize the scalar sum of the squares with respect to the matrix A. t denotes matrix transpose. w is a vector of unknown errors.

J(A)={Qₖ₊₁−Aₖ Qₖ}^{t}{Qₖ₊₁−Aₖ Qₖ} (6)

This gives us after some differentiation and matrix operations

Aₖ=[inv {Qₖ Qₖ^{t}}] [Qₖ₊₁ Qₖ^{t}]=[covariance of x] [Qₖ₊₁ Qₖ^{t}] (7)

Forecasting future concentrations one then uses

xₖ₊₁=Aₖ xₖ (8)

One can also make use of the covariance of A which can be used in conjunction with hypothesis testing to see if there is anything unusual with the measurement residuals (4). The concentrations of predicted CO₂ and water vapor can be used to update phase plane trajectories to identify progress of the chemical reaction. Possibly there are more than one equilibrium points. It is not enough to look at measurement amounts—due to all the factors previously exposed. If everything is going well, phase plane trajectories in each state should be spiraling into an equilibrium point. Additional information can be extracted from the eigenvalues of A.

```
Control of CO₂ measurement concentrations:
        simple lower bound control
  If xₖ₊₁ < 250 parts per million, do not
  reseed area
  If xₖ₊₁ > 250 parts per million, reseed
  area
```

Measurements

At +/−10 degrees polar circle, take 4 measurements 90 degrees apart. Each state variable, ie CO₂ concentration and H₂O concentration, should get measured thus, assuring redundancy and providing a best estimate measurement with an estimate of an error variance.

Seeding Technique

A simple air warming tunnel with a heating element to thaw crystallized CO₂ will be upwind from the entry, followed by fine aerosol (based on density of our oil dissolved chlorophyll) and ejection into the troposphere. Once CO₂ is aerated w/ chlorophyll and attached, it will not freeze again. Each state section should be done several times to encourage agitation of the air. Material amounts of needed chlorophyll is determined via a trial feedback mechanism. Chlorophyll is not destroyed, it can be burned, however, at high temperature, and ultimately destroyed, if need be. Passing the wind tunnel several times in weeks or months will ensure remixing. An excellent transport mechanism for the dispensing of Chlorophyll is extra virgin olive oil (9). Without affecting density of this oil significantly, additional synthetic chlorophyll can be added and aerated into the latter part of the air tunnel (10). Synthetic chlorophyll paste dissolves readily in an oily base.

Air Tunnel Specifications

Cylindrical steel 10 feet by 3 feet diameter. Electric resistance heating elements 1000 watts—total of 6, first 5 feet. Aerosol chamber, remaining 5 feet, one nozzle (9, 10). Connected to compressor and chlorophyll/oil reservoir 500 liter capacity. Brackets to secure to external aircraft frame to be used for transport seeding.

### References

b 1 F C Schweppe, “Uncertain Dynamic Systems”

2 J F Dopazo, IEEE PES. 3/20/2011 Phoenix, Ariz.

3 J F Dopazo, M H Dwarakanath, J J Li, A M Sasson “An External System Equivalent Model Using Real Time Measurements for System Security Evaluation” IEEE Transactions PA&S, vol PAS-96 pp 431-446, 1977.

4 J F Dopazo, O A Klitin, A M Sasson, “State Estimation for Power Systems: detection and identification of gross measurement errors” Proc. of the 8th IEEE PICA Conference, June 1973.

5 Linus Paulin, “General Chemistry”, Dover Publications

6 MIT Open Courseware—Chemistry Kinetics, Grad/Undergrad lectures (online)

7 Intercomparisons of Stratospheric water vapor sensors: Flash-B and NOAA/CDML frost point hygrometer, V. Hormel, V. Yushkov, et al

8 Synthesis of Chlorophyll A by Robert Woodward (1960). www.synarchive.com

9 Chlorophyll: Structural Properties, Health Benefits and Its Occurance in Virgin Olive Oils by A. Levent Inanc, Akademic Gida 9(2) (2011) 26-32

10 U.S. Pat. No. 5,455,055 Stoltz “Non-aerosol, uniform spray dispersion system for oil-based products

O A Klitin is an independent contractor with Capitaland Taxi, Saratoga Springs, N.Y.

1975-Sr. Engineer, Control Computer Section, Computer Applications Division, American Electric Power Service Corporation, 2 Broadway, NY, N.Y. 10004 BSEE and MSEE Northeastern University, Boston, Mass. 1967,1968

PhD Systems Engineering, Polytechnic Institute of Brooklyn, Brooklyn, N.Y. (dissertation incomplete) 1970.

Member of Phi Kappa Phi, Tau Beta Pi, Eta Kappa Nu, national academic honor societies.

1- Support to the floral contribution in the reduction of carbon dioxide.

2- Reduction of carbon dioxide at the poles and strengthening ice caps, eventually balancing worldwide amounts.

3- Support of industrial processes which, at this time, are impossible to change in totality. Adaptive changes in carbon dioxide control strategies as the automotive, electrical, and industrial processes change and improve emissions.

4- Lowering sea water levels and temperatures will result, long term. in less violent hurricane/tsunami incidences.

5- Extra virgin olive oil is a compatible base for mixing extra chlorophill a,b to be used in seeding process.
